(19) United States
(12) Patent Application Publication
(10) Pub. No.: US 2009/0039678 A1
(43) Pub. Date: Feb. 12, 2009

(54) Door Configuration for Automotive Vehicles

(76) Inventor: Huibert Mees, Plymouth, MI (US)

Correspondence Address: MILLER LAW GROUP, PLLC;AND FORD GLOBAL TECHNOLOGIES, INC., 25 STEVENS AVENUE, WEST LAWN, PA, 19609, US

(21) Appl. No.: 11/834,507

(22) Filed: Aug. 6, 2007

(51) Int. Cl. B62D 33/06

(52) U.S. Cl. 296/190.11

(57) ABSTRACT

A pick-up truck includes an operator and passenger compartment with both front and rear seating areas in which different door arrangements are provided on opposite sides of the operator and passenger compartment. On one side of the compartment, preferably the driver's side, the compartment is provided with a front door forwardly hinged on the A-pillar and a rear door forwardly hinged on the B-pillar of the vehicle frame in a crewcab configuration. On the opposing side of the compartment, preferably the passenger side, the compartment is provided with a forwardly hinged front door and a rearwardly hinged rear door of a supercab configuration. On the opposing passenger side of the compartment, the vehicle frame is not provided with a B-pillar to facilitate the loading and unloading of large objects from the rear seating area.

### FIELD OF THE INVENTION

This invention relates to door arrangements for automotive vehicles, and, more particularly, to a door configuration for a pick-up truck that facilitates effective utilization of the back seat of the cab of a pick-up truck.

### BACKGROUND OF THE INVENTION

The traditional door arrangement for a supercab pick-up truck is to use a forwardly hinged front door and a rearwardly hinged rear door so that when both the front and rear doors are opened the entire side of the operator's cab is opened. This door arrangement requires that the front door be opened before the rear door can be opened as the front door seals against a mating surface of the rear door when the doors are closed. This door arrangement creates a difficulty which commonly occurs in parking lot situations where the two open doors and the adjacent parked vehicle establishes a small space which is very difficult to maneuver in and is also difficult for the removal of objects and/or occupants from the car.

A crewcab pick-up configuration will have both the front and rear doors forwardly hinged and capable of operating independently, just as is known in passenger cars having a four door configuration. This crewcab door arrangement eliminates the maneuverability problem associated with the supercab door configuration, but suffers in the ability to load and unload large objects from the back seat of the vehicle. The supercab door arrangement has the advantage of allowing large objects to be easily loaded into and unloaded from the rear seat of the pick-up truck, but limits maneuverability and ease of passenger ingress and egress due to the need to open the front door in order to open the rear door.

In U.S. Pat. No. 6,053,561, issued to Walter Hojnowski, et al on Apr. 25, 2000, an improvement in the mounting of the rear door that is rearwardly hinged in the supercab configuration places the pivot axis of the hinges outward of the operating clearance and away from the opening in the cab of the pick-up truck to improve ingress and egress from the cab of the pick-up truck. The door system in U.S. Pat. No. 6,234,565 granted to Wade Bryant, et al on May 22, 2001, is a bi-fold door having a front panel and a rear panel hingedly connected and capable of sliding along longitudinal tracks to provide a opening for ingress and egress of the vehicle operator/passenger compartment.

An articulating door system is disclosed in U.S. Pat. No. 6,213,535 granted on Apr. 10, 2001, to Franklin Landmesser, et al, in which three doors are provided on the driver's side of the vehicle, including a forwardly hinged front door, a forwardly hinged middle door and an articulated third door that is pivoted from above and behind the third door to enable the door to be swung out and rearward of the middle door in front of it.

It would be desirable to provide a door configuration for a pick-up truck that can be utilized to facilitate the ingress and egress of passengers from one side of the vehicle and the loading of large objects from the opposite side of the vehicle.

### SUMMARY OF THE INVENTION

It is an object of this invention to overcome the aforementioned disadvantages of the known prior art by providing different door arrangements on opposite sides of an automotive vehicle.

It is another object of this invention to provide a pick-up truck that is manufactured with two forwardly hinged doors on one side of the vehicle and a forwardly hinged front door with a rearwardly hinged rear door on the opposing side of the vehicle.

It is a feature of this invention that the pick-up truck is formed with a B-pillar to support the forwardly hinged mounting of the rear door on only one side of the vehicle.

It is an advantage of this invention that one side of the pick-up truck can be used best for the loading of large objects into the rear seating area of the vehicle.

It is another advantage of this invention that the opposing side of the pick-up truck can be used optimally for the ingress and egress of passengers from the rear seating area of the vehicle.

It is still another object of this invention that the advantages of both the supercab door configuration and the crewcab door configuration can be realized on the same vehicle.

It is another feature of this invention that the driver's side of the pick-up truck cab can be configured with front and rear forwardly hinged doors to provide effective ingress and egress of passengers.

It is still another feature of this invention that the passenger side of the pick-up cab can be configured with a forwardly hinged front door and a rearwardly hinged rear door to provide effective access for loading and unloading large objects from the rear seating area of the vehicle.

It is yet another feature of this invention that the driver's side of the pick-up cab is best utilized to provide a door arrangement that facilitates the ingress and egress of passengers from the rear seating area because of the limitation of the steering wheel in the positioning of the front seat back to open the door opening for the effective loading and unloading of large objects from the rear seating area.

It is yet another object of this invention to provide a door configuration for a pick-up truck that facilitates both passenger ingress and the loading of large objects into the rear seating area of the pick-up truck, which is durable in construction, inexpensive of manufacture, carefree of maintenance, facile in assemblage, and simple and effective in use.

These and other objects, features and advantages are accomplished according to the instant invention by providing a pick-up truck having an operator and passenger compartment with both front and rear seating areas in which different door arrangements are provided on opposite sides of the operator and passenger compartment. On one side of the compartment, preferably the driver's side, the compartment is provided with a front door forwardly hinged on the A-pillar and a rear door forwardly hinged on the B-pillar of the vehicle frame in a crewcab configuration. On the opposing side of the compartment, preferably the passenger side, the compartment is provided with a forwardly hinged front door and a rearwardly hinged rear door of a supercab configuration. On the opposing passenger side of the compartment, the vehicle frame is not provided with a B-pillar to facilitate the loading and unloading of large objects from the rear seating area.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is an upper, left, front perspective view looking at the driver's side of a pick-up truck having a door configuration incorporating the principles of the instant invention, all the doors being depicted in the opened position;

FIG. 2 is an upper, right, front perspective view looking at the passenger side of a pick-up truck having a door configuration incorporating the principles of the instant invention, all the doors being depicted in the opened position; and

FIG. 3 is a top plan view of the pick-up truck shown in FIGS. 1 and 2 with all of the doors being shown in the open position.

### DETAILED DESCRIPTION OF THE PREFERRED EMBODIMENT

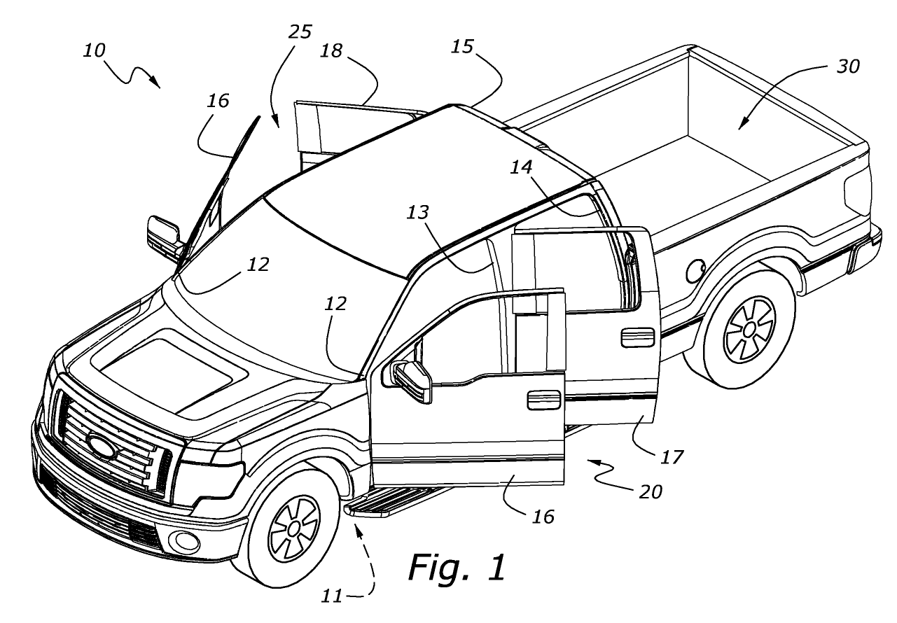

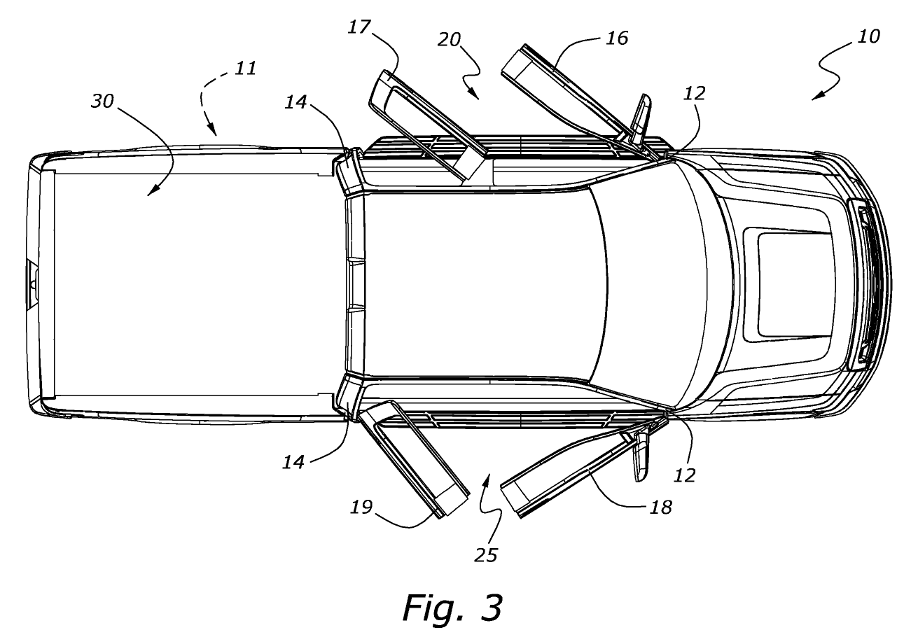

Referring to FIGS. 1-3, an automotive vehicle incorporating the principles of the instant invention can best be seen. Any references to left, right, front or rear being used as a matter of convenience and are determined be standing at the rear of the vehicle, such as at the left side of the drawing of FIG. 3, and looking at the forward end into the normal direction of travel. With this definition in a vehicle constructed for conventional operation in the United States of America, the driver's side would be on the left side of the vehicle, while the passenger side would be on the right side of the vehicle. While the instant invention is best utilized in conjunction with a pick-up truck as is shown in the drawings, one of ordinary skill in the art will recognize that vehicles other than a pick-up truck can be equipped with the door arrangement described in greater detail.

The vehicle 10, preferably a pick-up truck 10, is provided with an operator and passenger compartment 15 mounted on the frame 11 of the vehicle 10. In the pick-up embodiment, as is shown in the drawings, a load bed 30 is located behind the operator and passenger compartment 15. The operator and passenger compartment 15 is provided with a conventional front seat apparatus (not shown) on which the operator of the vehicle 10 is seated to operate the vehicle 10 and a conventional rear seating area (not shown) which is typically a rear seat on which passengers can be seated. In some configurations, the rear seating area can be removed or retracted into the floor to provide cargo area. For access into the front seat area of the vehicle 10, the operator and passenger compartment 15 is provided with forwardly hinged front doors 16, 18 that are pivotally mounted on the A-pillar 13 of the vehicle frame 11 on both the driver's side 20 and the passenger side 25 of the vehicle 10.

On one side 20, 25 of the vehicle 10, preferably the driver's side 20, the frame 11 is provided with a B-pillar 13 for the forward mounting of hinges that support the rear door 17 that opens forwardly in the normal manner of a crewcab pick-up truck configuration. The rear door 17, as is conventional with such door arrangements, is operable independently of the front door 16 and can be opened without requiring the front door 16 to be opened first. Accordingly, passengers can ingress and egress from the rear seating area effectively and efficiently without disturbing the operator or passengers in the front seat area. The two forwardly hinged front and rear doors 16, 17 on the driver's side of the vehicle 10 are best seen in FIGS. 1 and 3.

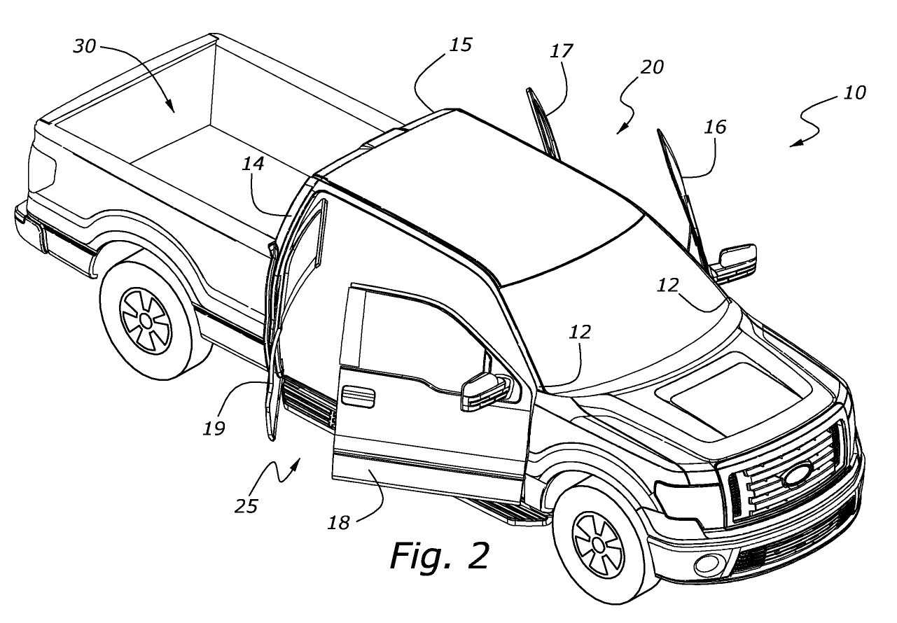

On the opposing side of the vehicle, preferably the passenger side 25, the frame 11 is not provided with a B-pillar, but is provided with a C-pillar 14, as is the driver's side 20. The rear door 19 on the passenger side 25 of the vehicle is rearwardly hinged to the C-pillar 14 such that the rear door 19 opens rearwardly in the conventional manner of a supercab pick-up truck configuration. Accordingly, the rear door 19 provides a mating sealing surface against which the front door 18 on the passenger side 25 closes. Thus, the rear door 19 on the passenger side 25 of the vehicle 10 cannot be opened unless the front door 18 on the passenger side 25 is opened first. However, when both the front and rear doors 18, 19 on the passenger side 25 are opened, the lack of a B-pillar 13 for the mounting of the rear door 19 allows the entire passenger side 25 of the operator and passenger compartment 15 to be opened for the loading and unloading of large objects from the rear seating area. The oppositely hinged front and rear doors 18, 19 on the passenger side 25 of the vehicle 10 can best be seen in FIGS. 2 and 3.

One skilled in the art will recognize that the oppositely hinged doors 18, 19 could be located on either side of the vehicle as desired, while the opposing side of the vehicle 10 were equipped with the two forwardly hinged front and rear doors 16, 17. However, the passenger side 25 is preferred for the oppositely hinged front and rear doors 18, 19 because the steering wheel (not shown) which is a limiting structure on the driver's side 20 of the vehicle 10 would limit the forward movement of the seat back of the front seat in order to provide as large an opening as possible for the loading of large objects into the rear seating area. Furthermore, in some vehicle set-ups, the front passenger seat can be configured to fold and retract against or into the floor at the front seating area to enlarge the cargo area from the rear seating area.

In operation, the forwardly hinged front and rear doors 16, 17, preferably on the driver's side 20 of the vehicle 10, can be utilized in a conventional manner as on a crewcab pick-up truck 10 for the driver and passengers to ingress and egress the operator and passenger compartment 15. Both doors 16, 17 are operable independently of each other. The oppositely hinged front and rear doors 18, 19, preferably on the passenger side 25 of the vehicle, can be utilized in a conventional manner as a supercab pick-up truck 10 for the loading and unloading of large objects, as described above, from the rear seating area. Certainly, the rear door 19 can be opened for the ingress and egress of passengers from the operator and passenger compartment 15; however, the rear door 19 will not be able to be opened unless the front door 18 is opened beforehand. Accordingly, the ingress and egress of passengers from the rear seating area on the passenger side 25 of the vehicle 10 is encumbered slightly due to the inability to open the rear door 19 without first opening the corresponding front door 18, but the loading and unloading of large objects from the rear seating area is greatly enhanced as compared to the two forwardly hinged front and rear doors 16, 17 on the driver's side of the vehicle 10.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

1. An automotive vehicle having a driver's side and a laterally opposing passenger side, comprising:
a frame having an A-pillar and a C-pillar on both said driver's side and said passenger side of said vehicle, said frame further having a B-pillar on only one of said driver's side and said passenger side;
a pair of front doors hingedly mounted respectively on the opposing A-pillars to establish a forwardly opening front driver's door and a forwardly opening front passenger door; and
a pair of rear doors mounted on said frame on opposing sides of said vehicle, one of said rear doors being hingedly mounted on said B-pillar so as to provide a forwardly opening rear door while the other rear door being hingedly mounted on the C-pillar on the side of said vehicle opposite from said B-pillar to provide an opposing rearwardly opening rear door.

2. The automotive vehicle of claim 1 wherein the rearwardly opening rear door is mounted on said passenger side of said vehicle.

3. The automotive vehicle of claim 2 wherein said rearwardly opening rear door is engaged by the corresponding forwardly opening front door such that said rearwardly opening rear door cannot be opened unless said corresponding forwardly opening front door is opened before said rearwardly opening rear door.

4. The automotive vehicle of claim 3 wherein said forwardly opening front door and the corresponding forwardly opening rear door are located on said driver's side of said vehicle.

5. The automotive vehicle of claim 4 wherein said vehicle is a pick-up truck.

6. In an automotive vehicle having an operator and passenger compartment defining a driver's side and a laterally opposing passenger side, the improvement comprising:
a forwardly hinged front door and a forwardly hinged rear door mounted on said driver's side of said vehicle; and
a forwardly hinged front door and a rearwardly hinged rear door on said passenger side of said vehicle such that the rear doors on opposing sides of said vehicle open in opposite forward and rearward directions.

7. The automotive vehicle of claim 6 wherein said automotive vehicle includes a frame having an A-pillar and a C-pillar on both said driver's side and said passenger side of said vehicle, said frame further having a B-pillar on said one of said driver's side and said passenger side.

8. The automotive vehicle of claim 7 wherein said forwardly hinged front doors are mounted on said A-pillars, said forwardly hinged rear door being mounted on said B-pillar and said rearwardly hinged rear door being mounted on said C-pillar on said other of said driver's side and said passenger side.

9. The automotive vehicle of claim 8 wherein said forwardly hinged front and rear doors are located on said driver's side of said vehicle, said rearwardly hinged rear door being located on said passenger side of said vehicle.

10. The automotive vehicle of claim 9 wherein said vehicle is a pick-up truck.

11. The automotive vehicle of claim 9 wherein said rearwardly opening rear door is engaged by the corresponding forwardly opening front door such that said rearwardly opening rear door cannot be opened unless said corresponding forwardly opening front door is opened before said rearwardly opening rear door.

12. A pick-up truck having an operator and passenger compartment supported on a frame forwardly of a cargo box, said operator and passenger compartment defining a driver's side and a passenger side, comprising:
a first front door hingedly mounted on a first A-pillar of said frame located on said driver's side of said operator and passenger compartment to define a first forwardly opening front door;
a second front door hingedly mounted on a second A-pillar of said frame located on said passenger side of said operator and passenger compartment to define a second forwardly opening front door;
a first rear door hingedly mounted on a B-pillar of said frame located on one of said driver's side and said passenger side of said vehicle to define a forwardly opening rear door operable independently of the corresponding said front door; and
a second rear door hingedly mounted on a C-pillar of said frame on the other of said driver's side and said passenger side of said vehicle to define a rearwardly opening rear door cooperable with the corresponding said front door such that said rearwardly opening rear door cannot be opened unless said corresponding said front door is opened before said rearwardly opening rear door.

13. The pick-up truck of claim 12 wherein said frame has said B-pillar only on one of said driver's side and said passenger side.

14. The pick-up truck of claim 13 wherein said forwardly opening rear door is located on said driver's side, said rearwardly opening rear door being located on said passenger side of said vehicle.
